(19) United States
(12) Patent Application Publication
(10) Pub. No.: US 2015/0169165 A1
(43) Pub. Date: Jun. 18, 2015

(54) System and Method for Processing Overlapping Input to Digital Map Functions

(71) Applicant: GOOGLE INC., (US)

(72) Inventor: John M. Bacus, Boulder, CO (US)

(73) Assignee: GOOGLE INC., Mountain View, CA (US)

(21) Appl. No.: 13/863,128

(22) Filed: Apr. 15, 2013

Related U.S. Application Data
(60) Provisional application No. 61/625,419, filed on Apr. 17, 2012.

(51) Int. Cl. G06F 3/0488

(52) U.S. Cl. CPC G06F 3/0488

(57) ABSTRACT

A digital map is displayed via a user interface. Input to a first mapping function, including a start gesture and an end gesture, is received via the user interface. Subsequently to detecting the start gesture but prior to detecting the end gesture, input to a second mapping function is received, and the second mapping function is applied to the digital map in accordance with the received input. The first mapping function then is applied to the digital map in accordance with the received input to the first mapping function.

### CROSS-REFERENCE TO RELATED APPLICATION

This application claims priority to U.S. Provisional Patent Application No. 61/625,419, filed on Apr. 17, 2012, and titled “User Interface for Tool Activation in a Computing Device,” the entire disclosure of which is hereby expressly incorporated by reference herein.

### FIELD OF THE DISCLOSURE

This disclosure generally relates to the user interface of a computing device and, more particularly, to a multitouch user interface for tool activation.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Today, a variety of devices including, for example, mobile phones, navigation systems, positioning systems, tablet computers, desktops, and laptops are configured to receive user input via one or more so-called multitouch interfaces that are capable of detecting simultaneous contact with a touchscreen at multiple points. Multitouch interfaces may provide a number of advantages over traditional interfaces. For example, multitouch interfaces may provide a more intuitive way for users to interact with software applications. Using multitouch interfaces, complicated operations that might normally require a number of keystrokes or mouse operations may be replaced by more natural hand or body gestures. Multitouch interfaces may also allow a user to provide more convenient inputs to an application than might otherwise be available using a traditional interface.

Typical multitouch user interfaces, however, are limited. While the interfaces may handle simple user interactions easily, the interfaces only allow for one software function to be active at a time. Because of this, it can be difficult for a user to operate complicated software tools or interact with multiple software tools or functions simultaneously (e.g., chorded operations). For example, in a computer aided design (CAD) software application, a user may wish to manipulate the view of an object while simultaneously operating on the geometry of the object. Typical multitouch interfaces may not be well-equipped to handle these inputs, and may only allow a user to perform one function at a time, not allowing the user to perform a second function (e.g., operating on the geometry of an object) until a first function is complete (e.g., manipulating the view of the object). These limitations may prevent users from performing certain operations and limit the usefulness of typical multitouch user interfaces.

### SUMMARY

According to an example implementation, a method for applying user gestures to digital maps displayed via a user interface is implemented in a computing device. The method includes displaying a digital map via the user interface and receiving input to a first mapping function via the user interface, where the input includes a start gesture and an end gesture. Subsequently to detecting the start gesture but prior to detecting the end gesture, the method includes (i) receiving input to a second mapping function, and (ii) applying the second mapping function to the digital map in accordance with the received input to the second mapping function. The method further includes applying the first mapping function to the digital map in accordance with the received input to the first mapping function.

In another implementation, a computing device includes a user interface configured to receive gesture-based input, one or more processors, and a computer-readable medium storing instructions. The instructions, when executed on the one or more processors, cause the computing device to (i) display, via the user interface, a graphics object and a function menu, (ii) receive a selection of a first function via the user interface, where the first function operates on the graphics object in accordance with input that includes a start gesture and an end gesture, (iii) detect application of the start gesture to the graphics object, (iv) subsequently to detecting the start gesture but prior to detecting the end gesture: receive a selection of a second function, receive input to the second function, and apply the second function to the graphics object, (v) detect application of the end gesture to the graphics object, and (vi) apply the first function to the graphics object in accordance with the received input.

In yet another implementation, a computer-readable medium storing instructions thereon for applying user gestures to graphic objects displayed on a touchscreen. The instructions, when executed on a processor, cause the processor to (i) display a digital map on the touchscreen, (ii) receive selection of a first mapping function via the touchscreen, (iii) receive input to the first mapping function via the user interface, where the input includes a start gesture and an end gesture, including: (a) detect the start gesture applied to the digital map, (b) subsequently to detecting the start gesture but prior to detecting the end gesture, receive selection of a second mapping function via the touchscreen, (c) modify the display of the digital map in accordance with the second mapping function, and (d) subsequently to modifying the display of the digital map in accordance with the second mapping function, detect the end gesture applied to the digital map, and (iv) apply the first mapping function to the digital map in accordance with the received input.

In still another implementation, a method for processing gesture-based user input to a graphics software application is implemented in a computing device having a touchscreen. The method includes displaying a function menu in a first area of the touchscreen and a graphics object in a second area of the touchscreen and detecting a selection of a first function via the function menu, where input to the first function is provided as a sequence of touchscreen events including a start event and an end event. The method further includes receiving a first portion of the sequence of touchscreen events via the second area of the touchscreen, where the first portion of the sequence includes the start event, and, prior to detecting the end event, detecting a selection of a second function via the function menu. Further, the method includes applying the second function to the graphics object in response to detecting the selection of the second function, detecting re-selection of the first function, receiving a second portion of the sequence of the touchscreen events in response, where the second portion of the sequence includes the end event, and, in response to detecting the end event, applying the first function to the graphics object using the received first portion of the sequence and the received second portion of the sequence as input.

In another implementation, a device includes an input device configured to receive gesture-based user input, a display device, a processor, and a memory unit storing instructions executable on the processor. The instructions include a multifunction processing module configured to display a 3D model of an object on the display device and receive first gesture-based input to a first function, where the first function is applied to the graphics object after each maof the first gesture-based input and second gesture-based input is received. The multifunction processing module is also configured to receive input to a second function prior to receiving the second gesture-based input, apply the second function to the 3D model using the received input to the second function, receive the second gesture-based input to the first function, and apply the first function to the 3D model using the received first gesture-based input and the received second gesture-based input.

In another implementation, a tangible non-transitory computer-readable medium stores instructions thereon for developing a 3D model. The instructions, when executed on a processor, cause the processor to render the 3D model on a display device and receive an indication that a user has selected a first function to be applied to the 3D model, where the first function requires first input and second input, and where the first function operates on a geometry of the 3D model. The instructions also cause the processor to receive the first input to the first function, prior to receiving the second input, receive an indication that the user has selected a second function to be applied to the 3D model, where the second function operates on a view of the 3D model, modify the view of the 3D model according to the second function, receive the second input to the first function, and modify the geometry of the 3D model according to the first function using the received first input and the received second input.

### BRIEF DESCRIPTION OF THE DRAWINGS

FIG. 1 is a block diagram of an exemplary touchscreen device configured to perform multifunction gesture processing in accordance with the techniques of the present disclosure;

FIG. 2 is a block diagram of an example multifunction processing module that can be implemented in the device of FIG. 1;

FIGS. 3A-3G are a series of diagrams that illustrate processing example gesture-based user input corresponding to two functions according to the techniques of the present disclosure;

FIG. 4 is a flow diagram of an example method for processing gesture-based user input corresponding to multiple functions that can be implemented in the device of FIG. 1; and

FIG. 5 is a state diagram that illustrates an example technique for processing gesture-based user input for multiple function that can be implemented in the device of FIG. 1.

### DETAILED DESCRIPTION

Generally speaking, techniques of the present disclosure allow a user to trigger, provide input to, and suspend or terminate multiple concurrent functions on a computing device via hand or body gestures. These multifunction processing techniques can be implemented in a multifunction processing module operating in a computing device equipped with a touchscreen, for example. More generally, a multifunction processing module may operate in any suitable system having a processor and one or several contact or motion sensors. In some implementations, the multifunction processing module recognizes a certain gesture (e.g., a swiping motion, a pause and hold motion, or a tapping motion) as a selection of a first device function. After the user begins providing input to the first function, but before the user completes the input, the multifunction processing module recognizes another gesture as a selection of a second function. The multifunction processing module then suspends the processing of input for first function and allows the user to provide input to the second function. When the second function is completed, the multifunction processing module reactivates the first function automatically or in response to a gesture. The multifunction processing module receives the remaining input and executes the first function using the input received prior to the activation of the second function as well as the input received after the completion of the first function.

In an example scenario, a portable tablet computer having a touchscreen executes software for three-dimensional (3D) modeling, and a multifunction processing module operates in, or cooperates with, the 3D modeling software to recognize gesture-based input for various functions. The modeling software displays a 3D model in one area of the touchscreen and an interactive menu in another area of the screen. By way of a more specific example, the 3D modeling software may display the interactive menu in the lower left corner of the touchscreen for access by the left hand (e.g., the left thumb), and the 3D model in the center of the touchscreen for access by the right hand (e.g., the right index finger). When a user wishes to draw a line cutting through the 3D model, the user selects the line drawing tool by tapping on the appropriate icon in the interactive menu. The multifunction processing module then detects a tap or another suitable type of contact at a certain location within the second area of the touchscreen and, in response, determines the first endpoint of a line segment according to the location of the tap. However, because the second endpoint of the line segment is obscured by the 3D model, the user taps on, or slides a finger to, an icon in the interactive menu that identifies the rotate tool. Without discarding the input specifying the first endpoint, the multifunction processing module activates the rotate function and allows the user to rotate the 3D model. The user then reactivates the line-drawing function by removing the finger from the rotate function icon and/or tapping on the line drawing tool icon, and taps at another location within the second area of the touchscreen to specify the second endpoint (without specifying again the first endpoint). The modeling software then draws a line segment connecting the first endpoint and the second endpoint.

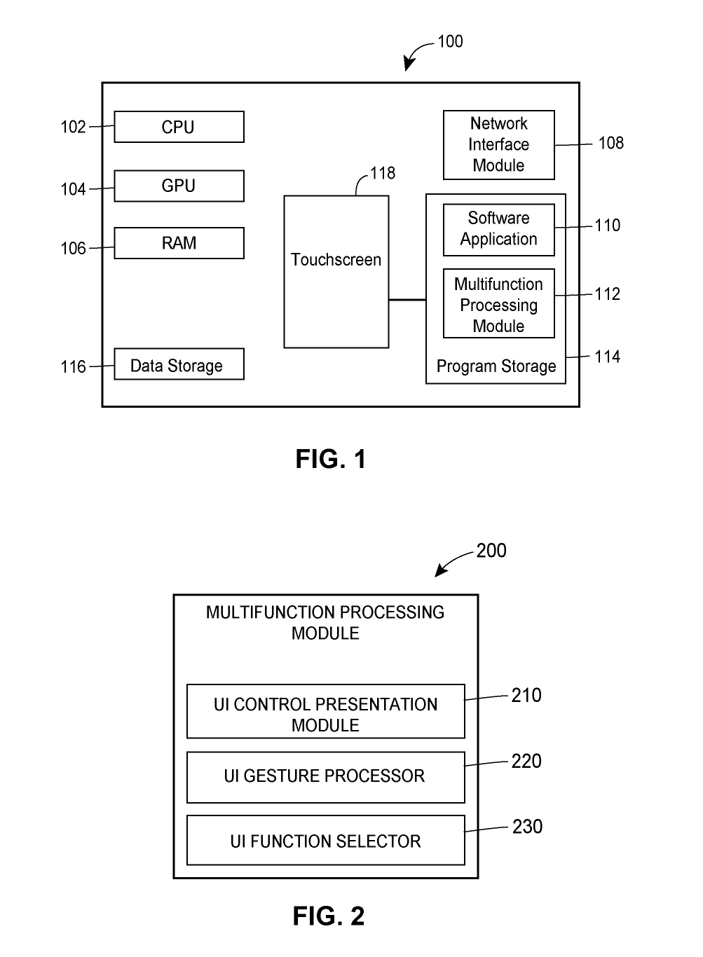

In the examples below, techniques for multifunction processing are discussed with reference to applications for rendering three dimensional models. However, it is noted that these techniques also can be used in other drawing or modeling applications that operate on graphics objects, as well as in non-drawing applications such as map editors, for example. For clarity, prior to discussing these techniques in more detail, an example touchscreen device that may implement these techniques is examined with reference to FIG. 1, and an example multifunction processing module that may operate in such a device is examined with reference to FIG. 2.

Further, in some implementations, the multifunction processing module concurrently processes more than two functions. To continue with the example of a 3D modeling application running on a portable tablet computer, a user can switch between a variety of tools that operate on the geometry of a model (e.g., drawing, stretching, skewing) as well as tools that operate on the view of the 3D model (e.g., rotation, zoom, pan) using appropriate single- and multi-finger gestures to select, suspend, and re-select tools as needed and switch between tools seamlessly. Thus, the user may begin to select an endpoint of a line segment, suspend the line drawing function to rotate, zoom, and reposition the model, and then select the second endpoint of the line segment and complete the operation. Similarly, in other software applications such as a mapping application, for example, a user can switch between various mapping tools (e.g., a path drawing tool, a map view tool and a map selection tool) using appropriate gestures.

Referring first to FIG. 1, an example device 100 includes a user input device such as a touchscreen 118 via which a user may provide gesture-based input to the device 100 using one or several fingers. In some implementations, a user may additionally or alternatively interact with the touchscreen 118 using a stylus. The device 100 may be a portable device such as a smartphone, a personal digital assistant (PDA), a tablet personal computer (PC), a laptop computer, a handheld game console, etc., or a non-portable computing device such as a desktop computer. The device 100 also may include one or more processors, such as a central processing unit (CPU) 102, to execute software instructions. In some implementations, the device 100 also includes a graphics processing unit (GPU) 104 dedicated to rendering images to be displayed on the touchscreen 118. Further, the device 100 may include a random access memory (RAM) unit 106 for storing data and instructions during operation of the device 100.

The device 100 may include a network interface module 108 for wired and/or wireless communications. For example, the network interface module 108 may include one or several antennas and an interface component for communicating on a 2G, 3G, or 4G cellular mobile communication network. Alternatively or additionally, the network interface module 108 may include a component for operating on an Wireless Local Area Network (WAN) such as an IEEE 802.11 network, for example. The network interface module 108 may support one or several communication protocols.

In addition to the RAM unit 106, the device 100 may include persistent memory modules such as a data storage 116 and a program storage 114 to store data and software instructions, respectively. In an implementation, the components 116 and 114 include non-transitory, tangible computer-readable memory such as a hard disk drive or a flash chip. The program storage 114 may store a multifunction processing module 112 that executes on the CPU 102 to interpret user gestures and allow users to perform multiple functions within a given software application. The multifunction processing module 112 may receive user commands from the touchscreen 118, interpret these commands, and interact with software application 110. In certain implementations, multifunction processing module 112 is a part of software application 110. In other implementations, multifunction gesture processing module 112 is provided as a separate component and interacts with software application 110 using any suitable techniques (e.g., as a dynamically linked library (DLL) via a set of Application Programming Interface (API) functions). The multifunction gesture processing module 112 may include compiled instructions directly executable on the CPU 102, scripted instructions that are interpreted at runtime, or both. The software application 110 and the multifunction processing module 112 may be stored in the program storage 114 as a set of instructions.

As an alternative, however, the device 100 may be implemented as a so-called thin client that depends on another computing device for certain computing and/or storage functions. For example, in one such implementation, the device 100 includes only volatile memory components such as the RAM 106, and the components 116 and 114 are external to the client device 100. As yet another alternative, the software application 110 and multifunction processing module 112 can be stored only in the RAM 106 during operation of the device 100, and not stored in the program storage 114 at all. In particular, the multifunction processing module 112 and/or the software application 110 can be provided to the device from the Internet cloud in accordance with the Software-as-a-Service (SaaS) model. The multifunction processing module 112 and/or the software application 110 in one such implementation are provided in a browser application (not shown) executing on the device 100.

In operation, the multifunction processing module 112 may process single- and multi-finger gestures using the techniques of the present disclosure. More particularly, an operating system or another component of the device 100 may generate low-level descriptions of touchscreen events (for simplicity, “events’) in response to the user placing his or her fingers on the touchscreen 118. The events may be generated in response to a series of interactions between a user and a touchscreen (e.g., new position of a finger relative to the preceding event) or upon expiration of a certain amount of time since the reporting of the preceding event (e.g., ten milliseconds), depending on the operating system and/or configuration. An event may specify the location of the point of contact with the touchcsreen. In some implementations, the operating system of the device 100 may provide additional information to the multifunction processing module 112, such as the pressure applied at the point of contact, the speed at which a point of contact moves along the surface of the touchscreen, acceleration of the point of contact, etc.

FIG. 2 is a block diagram of an exemplary multifunction processing module 200 with gesture support that can implement at least some of the described multifunction processing techniques. The multifunction processing module 200 of FIG. 2 may be implemented, for example, on a device similar to device 100 shown in FIG. 1 (e.g., as the multifunction processing module 112). In certain implementations, the module of FIG. 2 may be implemented using software modules (e.g., computer instructions stored on a computer-readable medium and interpretable by one or several processors), hardware modules, firmware modules, or any suitable combination thereof.

The multifunction processing module 200 may include user interface (UI) control presentation module 210, UI gesture processor 220, and UI function selector 230. Depending on the implementation, UI control presentation module 210, UI gesture processor 220, and UI function selector 230 may be separate modules. In other implementations, the modules 210, 220, and 230 may be combined into a single module. UI control presentation module 210, UI gesture processor 220, and UI function selector 230 may interact with each other as well as with other software stored on a hardware device. In certain implementations, multifunction processing module 200 may be part of a software application similar to software application 110 of FIG. 1. In other implementations, multifunction processing module 200 may be provided separately from a given software application, but the software application may access multifunction processing module 200 using known techniques (e.g., using dynamically linked libraries or through network access).

In an implementation, UI control presentation module 210 may receive input from a device interface similar to interface 118 of FIG. 1. Based on the input at the device interface, UI control presentation module 210 may interact with UI gesture processor 220, UI function selector 230, or with other device hardware or software components to generate or adjust an user interface display as necessary. In certain implementations, UI control presentation module 210 may interact with a software application similar to software application 110 of FIG. 1. Based on the received user input, UI presentation module 210 may receive data about the user input and adjust the device interface display accordingly. For example, in certain implementations, a user may press down on a certain location of a device touchscreen intending to bring up a selection menu. UI control presentation module 210 may receive information about the user interaction with the device interface (e.g., location of the point of contact, pressure applied at the point of contact, the duration of contact) and recognize that this type of input correlates to an instruction to open a selection menu. In response, UI control presentation module 210 may communicate with other device components or software modules to adjust the user interface display accordingly (e.g., display a selection menu on a screen). In certain implementations, UI control presentation module 210 may be used to modify the options presented on a pre-existing menu or to turn off a menu display. UI control presentation module 210 may also be used to display non-menu items, which may vary depending on the particular software application the user is interacting with. For example, in a 3D-modeling application, UI control presentation module 210 may be used to adjust the view or scale of a 3D object with which the user is interacting.

UI gesture processor 220 may be used to interpret user gestures received at a device interface similar to interface 118 of FIG. 1. In certain implementations, UI gesture processor 220 may be able to distinguish between various types of user interactions with a device interface and interpret the interactions accordingly. For example, gesture processor 220 may be able to distinguish between user gestures based on the number of simultaneous inputs (e.g., one finger or multiple fingers), the duration of the input (e.g., a short tap or a longer hold), the direction of the input (e.g., a straight line or a curved path), and various other distinct gesture characteristics. UI gesture processor 220 may be able to interpret these gestures based on gesture data stored in one or more device memories, such as, for example, RAM 106, data storage 116, and/or program storage 114 described above with respect to FIG. 1. In certain implementations, gesture data may also be stored remotely and accessed over a network.

UI function selector 230 may be used to interpret user gestures received at a device interface similar to interface 118 of FIG. 1 and may interact with other software and hardware modules operating on the device to activate certain device or application functionality based on the received gesture or gestures. In certain implementations, UI function selector 230 may interact with UI gesture processor 220 to activate a particular functionality based on the gesture interpreted by UI gesture processor 220. UI function selector 230 may also interact with an application running on a device, such as, for example, software application 110 of FIG. 1 to provide instructions on how the application should be operating at a certain time.

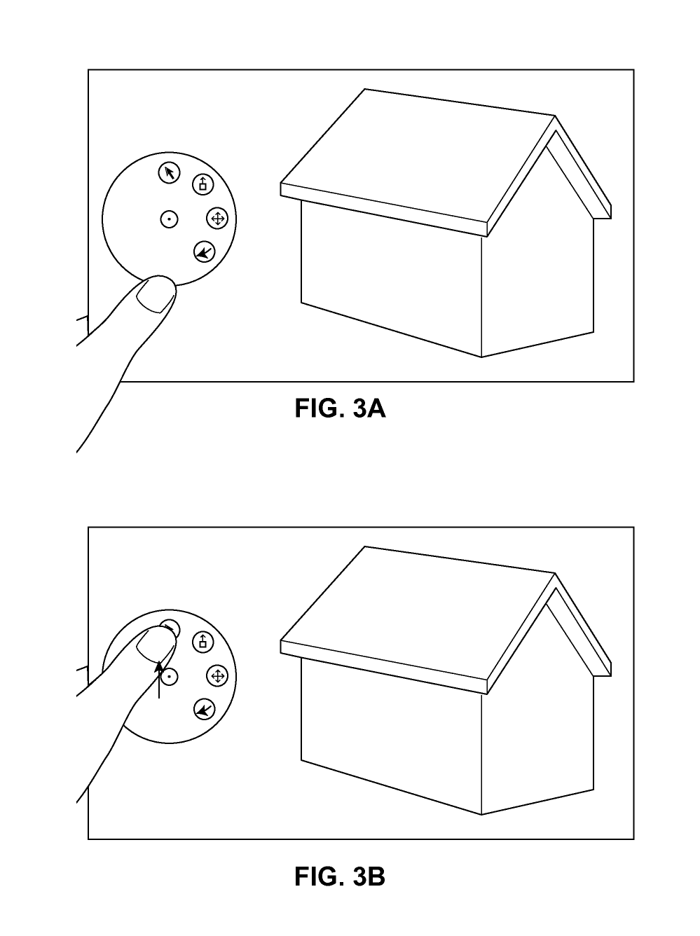

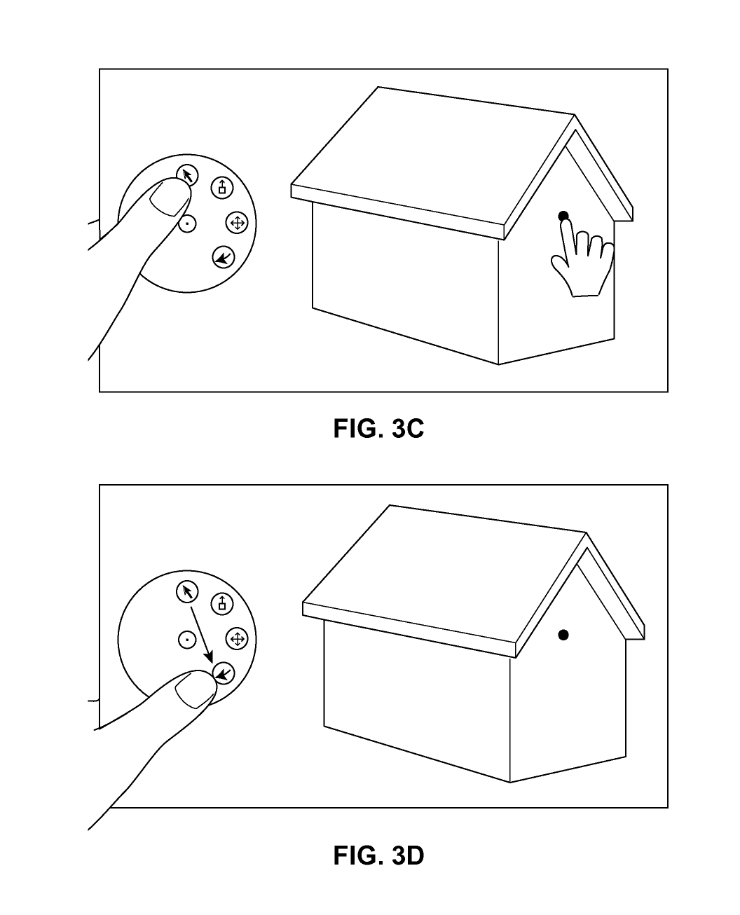

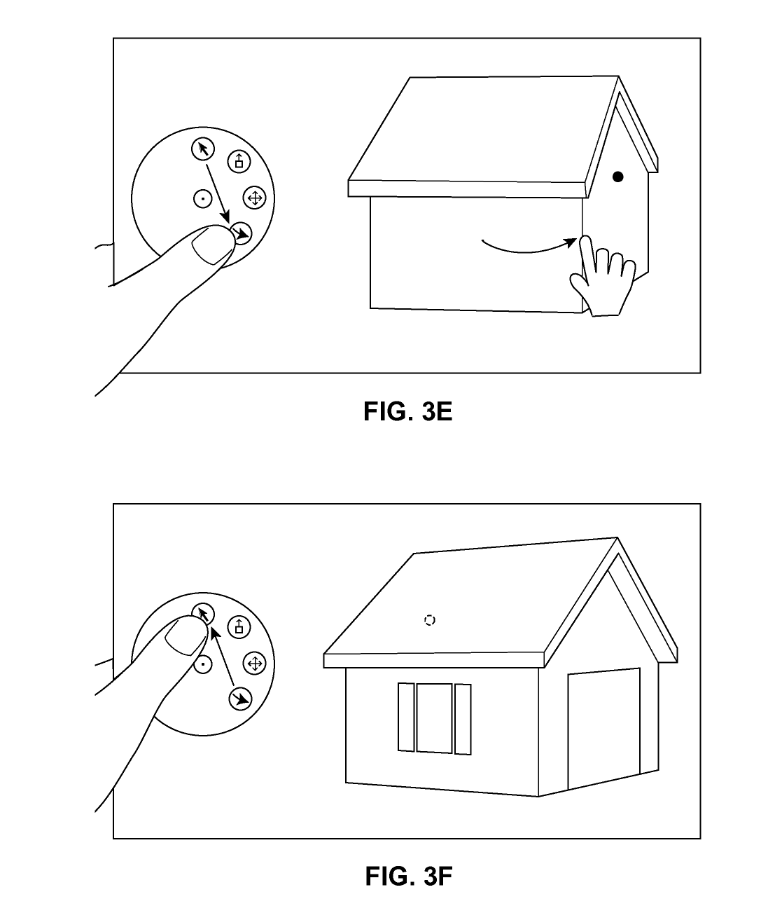

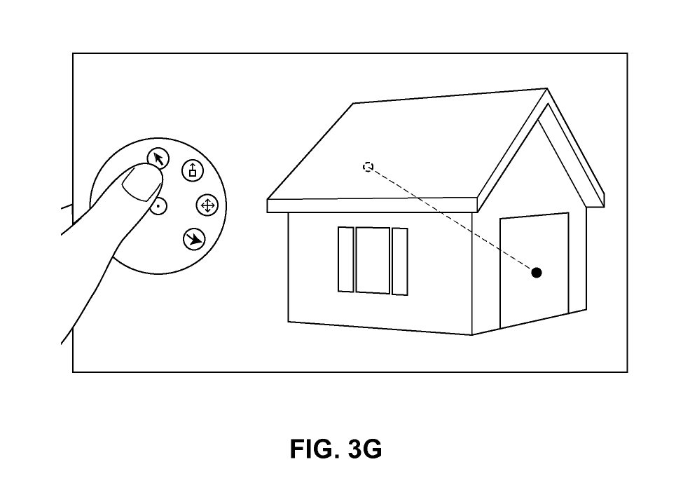

For example, a user may be modeling an object using a 3D modeling software application on a touchscreen device similar to device 100 of FIG. 1. More specifically, the user may wish to draw a line that cuts through an object by selecting a starting point on one side of the object using a line function, switching to a rotate function to rotate the object on the display, and switching back to and finishing the line function by selecting the ending point for the line after completing the rotate function. Throughout this process, UI control presentation module 210 and UI control gesture processor 220 may interpret the user's gestures and adjust the UI display accordingly, and UI function selector 230 may interact with the modeling application to activate the tool functionality and allow the user to begin using selected tools. A similar sequence of events is illustrated in FIGS. 3A-3G and will be described in more detail below.

FIGS. 3A-3G are a series of diagrams showing an exemplary method for processing gesture-based user input from a user so that the user may start using a first software function and put it on hold while temporarily using a second software function in a 3D modeling application. The method of FIG. 3 may be implemented, for example, in a device similar to device 100 shown in FIG. 1 and/or a module similar to multifunction processing module 200 shown in FIG. 2. In certain implementations, this method or similar methods may be implemented as computer programs developed in any suitable programming language and stored on a tangible, non-transitory computer-readable medium (such as one or several hard disk drives) and executable on one or several processors.

In the scenario of FIGS. 3A-3G, the user initially brings up the function menu by tapping on a toolbar with a finger on her dominant hand, for example. Alternatively, the user may use the thumb or another finger on her non-dominant hand to press and hold at a certain location on the touchscreen to bring up the function menu. In the example illustrated in FIG. 3A, the device is a portable tablet computer, and the function menu is displayed in the lower left corner of the touchscreen to allow a right-handed user to select menu items with her left thumb while holding the table computer, if necessary. However, if the user puts down or props up the tablet computer, she can also navigate the function menu with other fingers on her left hand. In an implementation, the user may specify whether she is right-handed or left-handed when configuring the 3D modeling application and/or the multifunction processing module, so that the function menu is displayed in the lower left corner if the user is right-handed, and in the lower right corner if the user is left-handed.

A 3D model (or, more generally, any suitable graphics object) is displayed in another area of the touchscreen that is suitable for access by the user's dominant hand. In some implementations, the area in which the 3D model is displayed corresponds to the entire area of the touchscreen not occupied by the function menu. It is also noted that the area in which the user can provide gesture-based input to a function selected via the function menu need not be limited to the portion of the touchscreen occupied by the 3D model. In particular, a toolbar, separate icons, or other controls corresponding to various functions can be displayed next to, or over, the 3D model, and the user can interact with these controls with the dominant hand while continuing to interact with the function menu with the non-dominant hand. As a more specific example, an icon for a predetermined degree of rotation (e.g., 90 degrees) can be displayed above the 3D model and separately from the function menu.

In an exemplary modeling application, the function menu provides a selection of different functions the user can perform within the modeling application. The functions in general may operate on the geometry of a 3D model and on the view of the 3D model. More specifically, functions for defining or modifying the geometry of a 3D model can include tools for drawing lines, curves, 2D shapes, 3D objects such as cubes and spheres, etc. Functions for modifying the view of the 3D model include rotate, zoom, scale, pan (reposition), etc.

Some functions selectable via the function menu may receive input that includes a sequence of touchscreen events. For example, to add a line to a graphics object, an example 3D modeling application needs to detect a start event such as a tap to determine the first endpoint of a line segment, and an end event, which also may be a tap, to determine the second endpoint of the line segment. The sequence also may include one or several swipes or other gestures between the start event and the end event. Thus, the user may provide a “start gesture” by tapping on the touchcsreen one or more times (at a location where the user wishes to set the first endpoint) and an “end gesture” by tapping on the touchcsreen one or more times. More generally, each of the start event and the end event can be any suitable gesture or a sub-sequence of gestures that can be processed separately from other gestures. The gestures can be relatively simple (e.g., a tap) or complex (e.g., a pinch that requires movement of fingers toward each other at a particular rate and/or angle). It is also noted that the start event need not be similar to the end event, although the start event and the end event correspond to the same type of gesture in some of the implementations.

In FIG. 3B, the user slides his finger up to the appropriate icon in the function menu to select the line drawing tool. When the user selects the line tool, multifunction processing module 200 may interact with the 3D modeling application to begin the line function, allowing the user to begin drawing or editing a line in a 3D model.

In FIG. 3C, while continuing to press the touchscreen interface with the finger used to select the line drawing function, the user may use his other hand to provide input to the line drawing function. In FIG. 3C, in order to begin drawing a line through the illustrated object, the user selects the first endpoint on the illustrated graphics object (a 3D model of a house). In this example, he touches the touchscreen with the index finger of his dominant hand while continuing to hold down on the interface with his non-dominant hand. Touching the screen with the user's dominant hand corresponds to the start gesture for the line drawing command. In certain implementations, the user may not be required to hold down on the interface with his non-dominant hand while performing a function with his dominant hand. In other implementations, if the user interacts with the menu using his dominant hand, he may begin using a selected function with his non-dominant hand.

After a user has started to use the first function (in this case, the line-drawing function), he may wish to temporarily switch to a second function, such as rotate, before completing the input to the first function. As discussed above, the input to the line drawing function includes a second endpoint, but, in the example scenario of FIGS. 3A-3G, the two endpoints of the line segment the user wishes to draw lie on opposite sides of the 3D model. Because the target location of the second endpoint is obscured in the view of FIGS. 3A-3C, the user cannot tap on the touchscreen to directly specify the second endpoint.

Accordingly, as illustrated in FIG. 3D, the user selects the rotate function in the 3D modeling application by sliding his thumb down to the rotate tool icon displayed on the function menu. If the user has already lifted his non-dominant hand from the screen, but the function menu is still displayed, he may select the rotate function (similar to any other displayed function not currently in use) by simply tapping on or holding down the appropriate icon or text without performing a sliding gesture. Further, if the user is using his non-dominant hand to perform object actions (e.g., drawing lines, rotating objects, or other selected operations), he may make menu selections with his dominant hand.

After the user selects the rotate function for temporary activation, the first function may be placed on “hold” temporarily and its status may be stored in a device memory. For example, when the user switches from the line drawing function to the rotate function, the multifunction processing module 200 may store the partial input to the line drawing function, along with an appropriate status indicator for the line function, in memory. Referring back to FIG. 1, data related to the suspended line drawing function may be stored in the RAM 106, the data storage 116, or both. For clarity, the 3D modeling application may continue displaying the first endpoint while the line drawing function is on hold. The multifunction processing module 200 may also check to confirm that the user has made a valid selection because certain types of functions may not be compatible with each other, or a user may have to perform certain steps before selecting certain types of functions. For example, a user may not be able to select a “paste” function if he has not already selected a “cut” or “copy” function. Similarly, if a user is manipulating a two-dimensional planar object, he may not be able to perform a rotate function on the object. If the user selects an “invalid” selection, the software may provide an error message to the user and/or prompt him to make another selection. Alternatively, the application may make certain menu functions unselectable at the appropriate time or times.

After making his selection, the user may being using the selected “temporary” function. In FIG. 3E, the user provides input to the rotate function with his right hand while continuing to press down on the rotate icon in the function menu using his left hand. Again, in certain implementations, the user may not be required to continue pressing down on the icon while performing a function with his dominant hand. In other implementations, if the user is using the menu using his dominant hand, he may begin using a selected function with his non-dominant hand. In FIG. 3E, the user rotates the 3D model by swiping a finger horizontally across the screen. The rotate command may include one or more swipes, depending on how far the user wishes to rotate the object or in what direction the user wishes to rotate the object. For example, to rotate an object clockwise, the user may swipe his fingers from right to left. To rotate an object counterclockwise, the user may swipe his fingers from left to right. The user may also rotate the object at different angles and across different axes by performing one or more swipes his fingers across the touchscreen interface accordingly. In some cases, the user may rotate the 3D model several times and along different axis while the line drawing function is suspended. More generally, the user can choose as many functions for modifying the view of the 3D model as desired before returning to the line drawing function. For example, in some scenarios, the user may need to both rotate and zoom in on a portion of the 3D model to be able to select the second endpoint of the line segment.

In FIG. 3F, the user completes the temporary use of the rotate function and resumes the originally selected line drawing function. The user may complete the temporary function in a number of ways. For example, the multifunction processing module 200 may recognize a certain gesture as the end gesture for the rotate function or, more generally, a view modification function. In another implementation, the user completes the temporary function by reselecting the line drawing function via the function menu. In yet other implementations, the temporary function automatically completes after a preconfigured period of time, or if the device does not detect user activity for a specified time. In the example of FIG. 3F, the user slides his left thumb back to the line drawing icon.

After the user makes his selection, the multifunction processing module 200 may confirm that the user has made a valid selection. The user may not be able to resume the original function at certain times, or the user may have to take additional steps before resuming the suspended function. For example, the multifunction processing module 200 can prevent the user from reactivating the line drawing function if the graphics object on which he is working is no longer displayed on the screen. If the user makes an invalid selection, the multifunction processing module 200 may provide an error message to the user and/or prompt him to make another selection. When the user makes a valid selection, the multifunction processing module 200 may update the status of the line drawing function, so that the user can resume where he left off.

In FIG. 3G, the user completes the originally selected line drawing function. In particular, the user specifies the second endpoint by tapping on the touchscreen at the desired location, and the multifunction processing module 200 applies the first partial input provided at the stage illustrated in FIG. 3C and the second partial input provided at the stage illustrated in FIG. 3G to the line drawing function. The multifunction processing module 200 then allows the 3D modeling software to apply the line drawing function to the 3D model. As illustrated in FIG. 3G, the resulting line segment in this example passes through the 3D model, with only one endpoint being on a visible plane at a time.

Similar methods may also be used in mapping applications. For example, a user may manipulate a map to draw a custom route, highlight portions of various map locations, mark locations on a map, and/or select portions of a map to edit or save. In an implementation in which a user wants to draw a custom route on a map, for example, the user may use methods similar to those described above to switch between a zoom function and a line drawing function or any other relevant function. More specifically, a user may select a line drawing function similar to those described above to begin drawing the route and may temporarily pause the line drawing function to zoom in or out of a map as necessary to more easily draw the route. The user may switch between functions using a method similar to that described above.

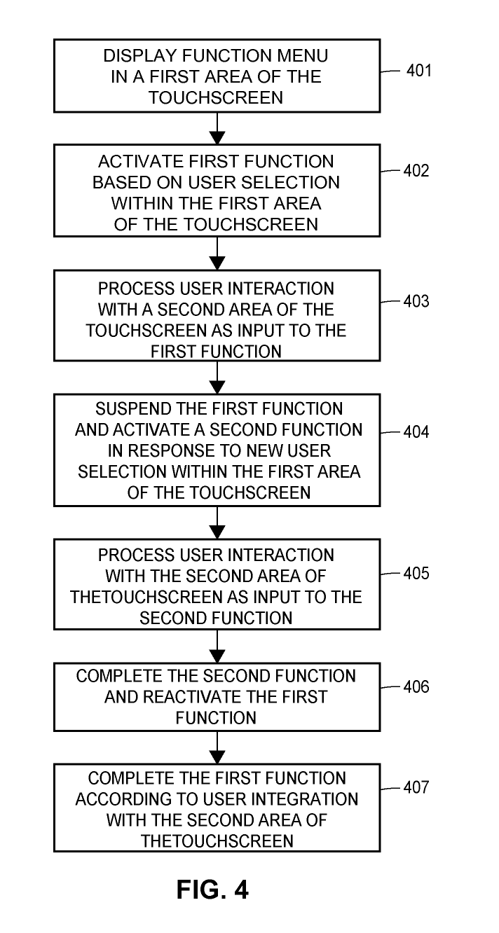

FIG. 4 is a flow diagram of an exemplary method for processing multifunctional gesture-based user input from a user to allow the user to temporarily suspend a first function to use a second function in a software application. The method shown in FIG. 4 generally may be applied to various types of applications such as, for example, a 3D modeling application (described above with respect to FIG. 3) or a mapping application. In an example implementation, the method of FIG. 4 is implemented in the device 100 of FIG. 1 and/or the multifunction processing module 200 of FIG. 2 as a set of instructions stored in a memory and executable on a processor.

At block 401, the device may display a function menu in a first area of the touchscreen, such as the lower corner easily accessible by the left hand of the user. Depending on the software application and the type and size of a touchscreen with which the user is interacting, a wide variety of user gestures may be recognized as an instruction to display the function menu (e.g., long press, short press/tap, single swipe, multiple swipes, etc.). For example, in one implementation, the user presses down on the touchscreen at a particular location for a sufficiently period of time to trigger the display of the function menu. The device in another implementation displays the function menu in response to the user selecting the corresponding option in the toolbar provided at the top or on the side of the touchscreen. The function menu may present different functions the user can perform depending on the software application the user is running.

At block 402, after the user selects the first function based on the options presented in the displayed function menu, the device may activate the first function based on the user selection. For example, the user may, without lifting his finger off the touchscreen, slide up the finger she used to bring up the function menu to select the first function in the function menu. In certain software applications, he may select the first function even after lifting her finger off the surface of the touchscreen. If convenient, he may also make the selection with a different finger or hand. The device may be configured to recognize these gestures and activate the selected function accordingly.

The first function requires that a sequence of touchscreen events be received as input for a single instance of execution. The sequence in general includes a start event, an end event, and any suitable number of intermediate events. At block 403, the device receives partial input for the first function based on detected user interaction with the touchscreen in a second area where a graphics object, such as a 3D model, is displayed. However, because the partial input to the first function provided at block 403 does not include the end event, the first function cannot yet be executed.

Next, at block 404, the device temporarily pauses or suspends the first function while launching a second function, in response to user interactions with the first area of the touchscreen (where the function menu may be displayed). As discussed above, the user may slide his finger from an icon corresponding to the first function to an icon corresponding to the second function. After the user selects the second function, the software application that implements the method of FIG. 4 may place the first function on hold and store the status of the first function in a device memory. In some cases, the software application also checks to confirm that the user has made a valid selection as certain types of functions may not be compatible with each other. If the user selects an invalid function, the software application may provide an error message to the user and/or prompt her to make another selection. Alternatively, the software application may make certain menu functions unselectable at the appropriate time or times.

In some cases, the method of FIG. 4 includes block 405, at which the device receives input to the second function in the form of one or more gestures. The user may interact with the area of the touchscreen where the graphics object is displayed using swipe, pinch, and/or other suitable gestures. In other cases, however, block 405 can be omitted if the selection of the second function also constitutes the complete input to the second function. For example, if the user selects the “rotate clockwise by 90 degrees” function, no additional input is required from the user, and the function is performed immediately upon selection.

At block 406, the second function completes, and the first function is reactivated automatically or in response to a user action. For example, the second function may be a discrete rotate function that rotates a graphics object 90 degrees, and the first function may be resumed automatically upon completion of the discrete rotate function at block 406. In another implementation, the first function must be explicitly reselected for reactivation, so that the user can activate multiple functions prior to resuming the first function, if desired. For example, according to this implementation, the user can, after suspending the first function, rotate the graphics object 90 degrees, reposition the graphics object on the screen, zoom in on a portion of the graphics object, and only then explicitly reselect the first function.

The flow then proceeds to block 407, where the originally selected first function is completed. In particular, the remaining input to the first function is received, combined with the partial input received at block 403, and provided to the first function, which is then applied to the graphics object.

A method similar to the method of FIG. 4 can be used to support more than two overlapping functions, and accordingly allow a user to suspend more than one function. In particular, after a user suspends a first function after providing only partial input for executing the first function, the user may select a second function that also requires a start event and an end event and, after triggering the start event but before providing the end event, suspend the second function to launch a third function.

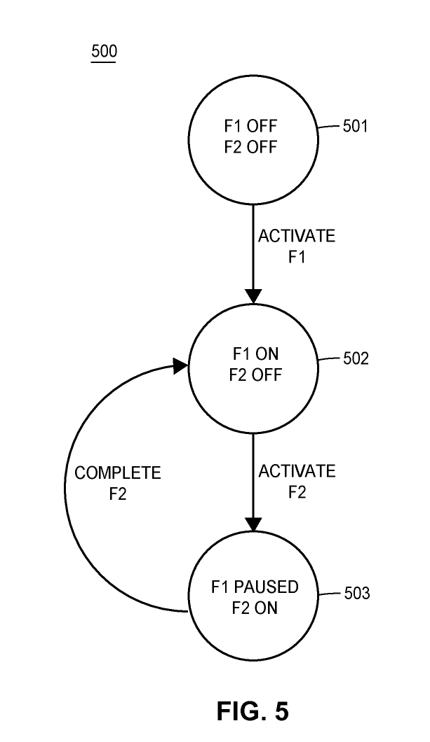

For clarity, FIG. 5 depicts a state diagram 500 to illustrate some of the states associated with processing gesture-based user input from a user, so that the user may start using a first software function and put it on hold while temporarily using a second software function. The states may be implemented on a device similar to device 100 of FIG. 1. More specifically, the states may be implemented using one or more multifunction processing modules similar to multifunction processing module 200 of FIG. 2. Any of the given states in FIG. 5 may be associated with one or more variables or user and/or device actions. For example, as described below, in state 501, two functions within a given software application are turned off. The status of one or more of the functions may be represented by variables stored on the device indicating that a given function is active, off, paused, or any other suitable status. Further, a given state may be associated with one or more user and/or device actions. For example, an application may transition from state 501 to state 502 based on one or more user interactions with a device that correspond to selecting a given function using a function menu as described above. Similarly, an application transitions from state 503 to 502 based on one or more user interactions with a device that correspond to reselecting a given function after completing a temporary function as described above. The series of user interactions and device and software actions associated with the user interactions may be considered triggering events. Within a given application, transitions between certain functions may be restricted at certain times or not allowed at all. Because states correspond to the statuses of the various functions, transitions between states may also be restricted at certain times or not allowed at all, based in part on the current state of the function and application.

In state 501, both a function F1 (e.g., a line drawing function) and a function F2 (e.g., a rotate function) are turned off. An application may be in the state, for example, shortly after opening a software application and before any functions have been selected, or after a user has completed all previously running functions.

In state 502, F1 has been activated while F2 remains off. The application may transition from state 501 to state 502 when the user initially selects F1 after opening a function menu as described above. Similarly, the application transitions from state 503 to 502 after completing a temporary use of function F2 as described above.

In state 503, F1 has been temporarily paused/deactivated while F2 is on. The application may transition from state 502 to state 503 after detecting the selection of a second function for temporary use while the first function is paused or is put on hold.

Although the examples above focused primarily on 3D modeling applications, the techniques of the present disclosure also can be applied in other applications such as map viewing and editing software, for example. As a more specific example, a touchscreen device such as a mobile phone may execute a mapping application that utilizes multifunction processing techniques to allow users to perform several overlapping functions. A user may manipulate a map to draw a custom route, highlight portions of various map locations, mark locations on a map, and/or select portions of a map to edit or save, etc. At some point, the user may select a function that requires an input including several touchscreen events, such as drawing a line segment over a map to represent a portion of a path. The user may suspend the selected function to rotate the map, for example, and resume providing input to the originally selected function.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain implementations are described herein as including logic or a number of components, modules, or mechanisms. Modules may constitute either software modules (e.g., code implemented on a tangible, non-transitory machine-readable medium such as RAM, ROM, flash memory of a computer, hard disk drive, optical disk drive, tape drive, etc.) or hardware modules (e.g., an integrated circuit, an application-specific integrated circuit (ASIC), a field programmable logic array (FPLA), etc.). A hardware module is tangible unit capable of performing certain operations and may be configured or arranged in a certain manner. In example implementations, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one implementation” or “an implementations” means that a particular element, feature, structure, or characteristic described in connection with the implementation is included in at least one implementation. The appearances of the phrase “in one implementation” in various places in the specification are not necessarily all referring to the same implementation.

Some implementations may be described using the expression “coupled” along with its derivatives. For example, some implementations may be described using the term “coupled” to indicate that two or more elements are in direct physical or electrical contact. The term “coupled,” however, may also mean that two or more elements are not in direct contact with each other, but yet still co-operate or interact with each other. The implementations are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the implementations herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative designs and implementations for a device and a method for processing gesture-based user input from a user through the disclosed principles herein. Thus, while particular implementations and applications have been illustrated and described, it is to be understood that the disclosed implementations are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method in a computing device for applying user gestures to digital maps displayed via a user interface, the method comprising:
displaying a digital map via the user interface;
receiving input to a first mapping function via the user interface, wherein the input includes a start gesture and an end gesture;
subsequently to detecting the start gesture but prior to detecting the end gesture, (i) receiving input to a second mapping function, and (ii) applying the second mapping function to the digital map in accordance with the received input to the second mapping function; and
applying the first mapping function to the digital map in accordance with the received input to the first mapping function.

2. The method of claim 1, wherein the first mapping function is a line drawing function, and wherein applying the first mapping function to the digital map includes:
determining a first endpoint based on the start gesture,
determining a second endpoint based on the end gesture, and
drawing a line segment over the digital map from the first endpoint to the second endpoint.

3. The method of claim 2, wherein the start gesture and the end gesture are instances of one of (i) a tap gesture or (ii) a double-tap gesture.

4. The method of claim 2, wherein applying the second mapping function to the digital map includes changing a zoom level of the digital map.

5. The method of claim 1, wherein receiving the input to the first mapping function includes:
receiving partial input to the first mapping function, wherein the partial input includes the start gesture,
receiving a command via the user interface to suspend the input to the first mapping function subsequently to receiving the partial input but prior to receiving the end gesture, and
subsequently to receiving the input to the second mapping function, automatically resuming the input to the first mapping function.

6. The method of claim 1, wherein:
the user interface includes a touchscreen, and
the start gesture and the end gesture are finger gestures applied to the touchscreen.

7. The method of claim 1, wherein the user interface includes a first area suitable for access by the dominant hand and a second area suitable for access by the non-dominant hand, the method further comprising:
receiving the input to the first mapping function and the input to the second mapping function in the first area; and
providing, in the second area, a function selection menu for selecting the first mapping function and the second mapping function.

8. The method of claim 7, further comprising:
receiving, via the function selection menu, a selection of the first mapping function; and
receiving, via the function selection menu, a selection of the second mapping function subsequently to receiving the start gesture but prior to receiving the end gesture.

9. A computing device comprising:
a user interface configured to receive gesture-based input;
one or more processors; and
a computer-readable medium storing thereon instructions that, when executed on the one or more processors, cause the computing device to:
display, via the user interface, a graphics object and a function menu,
receive a selection of a first function via the user interface, wherein the first function operates on the graphics object in accordance with input that includes a start gesture and an end gesture,
detect application of the start gesture to the graphics object,
subsequently to detecting the start gesture but prior to detecting the end gesture: (i) receive a selection of a second function, (ii) receive input to the second function, and (iii) apply the second function to the graphics object,
detect application of the end gesture to the graphics object,
apply the first function to the graphics object in accordance with the received input.

10. The computing device of claim 9, wherein the graphics object is a digital map.

11. The computing device of claim 9, wherein the instructions further cause the computing device to:
determine a first endpoint of a line segment based on the start gesture,
determine a second endpoint of the line segment based on the end gesture, and
draw the line segment between the first endpoint and the second endpoint upon detecting the end gesture.

12. The computing device of claim 11, wherein the second function is one of (i) a rotate function, (ii) a zoom function, or (iii) a pan function.

13. The computing device of claim 12, wherein:
a point on the user interface to which the end gesture is applied is inaccessible to a user at a time when the start gesture is detected, and
the point on the user interface to which the end gesture is applied becomes accessible to the user after the second function is applied to the graphics object.

14. The computing device of claim 9, wherein the user interface includes a touchscreen.

15. The computing device of claim 12, wherein the touchscreen includes a first area suitable for access by the dominant hand and a second area suitable for access by the non-dominant hand, wherein the instructions further cause the computing device to:
receive the input to the first mapping function and the input to the second mapping function in the first area, and
provide, in the second area, a function selection menu for selecting the first mapping function and the second mapping function.

16. A computer-readable medium storing instructions thereon for applying user gestures to graphic objects displayed on a touchscreen, wherein the instructions, when executed on a processor, cause the processor to:
display a digital map on the touchscreen;
receive selection of a first mapping function via the touchscreen;
receive input to the first mapping function via the user interface, wherein the input includes a start gesture and an end gesture, including:
detect the start gesture applied to the digital map,
subsequently to detecting the start gesture but prior to detecting the end gesture, receive selection of a second mapping function via the touchscreen,
modify the display of the digital map in accordance with the second mapping function, and
subsequently to modifying the display of the digital map in accordance with the second mapping function, detect the end gesture applied to the digital map; and
apply the first mapping function to the digital map in accordance with the received input.

17. The computer-readable medium of claim 16, wherein to modify the display of the digital map in accordance with the second mapping function, the instructions cause the processor to receive gesture-based input to the second mapping function via the touchscreen.

18. The computer-readable medium of claim 16, wherein the second mapping function is a zoom change function.

19. The computer-readable medium of claim 16, wherein the start gesture and the end gesture are instances of one of (i) a tap gesture or (ii) a double-tap gesture.

20. The computer-readable medium of claim 16, wherein the touchscreen includes a first area suitable for access by the dominant hand and a second area suitable for access by the non-dominant hand, and wherein the instructions further cause the computing device to:
receive the input to the first mapping function and the input to the second mapping function in the first area; and
provide, in the second area, a function selection menu for selecting the first mapping function and the second mapping function.
